(19) United States
(12) Patent Application Publication
(10) Pub. No.: US 2025/0124730 A1
(43) Pub. Date: Apr. 17, 2025

(54) METHOD AND APPARATUS FOR GENERATING TEXT DESCRIPTION FOR IMAGE, ELECTRONIC DEVICE, AND MEDIUM

(71) Applicant: Beijing Youzhuju Network Technology Co., Ltd., Pinggu District (CN)

(72) Inventors: Zhengyin Du, Beijing (CN); Zehuan Yuan, Beijing (CN)

(21) Appl. No.: 18/887,402

(22) Filed: Sep. 17, 2024

(30) Foreign Application Priority Data
Oct. 16, 2023 (CN) 202311337480.6

(51) Int. Cl. G06V 20/70; G06V 10/44

(52) U.S. Cl. CPC G06V 20/70; G06V 10/44

(57) ABSTRACT

Embodiments of the present disclosure relate to a method and apparatus for generating a text description for an image, an electronic device, and a medium. The method includes generating a first feature of the image through a visual encoder, where a text encoder semantically aligned with the visual encoder is used to train a conversion model and a language model. The method further includes converting the first feature into a second feature through the conversion model, where the first feature and the second feature correspond to different feature spaces. In addition, the method also includes generating, by the language model, a text description for the image based on the second feature.

CROSS-REFERENCE TO RELATED APPLICATION(S)

This application claims priority to Chinese Application No. 202311337480.6 filed Oct. 16, 2023, the disclosure of which is incorporated herein by reference in its entirety.

### FIELD

The present disclosure generally relates to the computer field, and more specifically, to a method and apparatus for generating a text description for an image, an electronic device, and a medium.

### BACKGROUND

With the development of technology, the application of neural network models such as a large language model has become increasingly widespread. The large language model refers to a neural network model trained using a large amount of text data, which has important application value in the fields such as situational dialogue, text generation, and language classification.

With the increase in usage scenarios and demands, multimodal large language models have gradually become an important development direction for natural language processing. In multimodal application scenarios, the large language model needs to process not only text input but also input such as speeches, images, and videos. Therefore, accurate and efficient input content understanding and learning capabilities are particularly important for the multimodal large language models.

### SUMMARY

Embodiments of the present disclosure provide a method and apparatus for generating a text description for an image, an electronic device, and a medium.

In a first aspect of the present disclosure, a method for generating a text description for an image is provided. The method includes generating a first feature of the image through a visual encoder, where a text encoder semantically aligned with the visual encoder is used to train a conversion model and a language model. The method further includes converting the first feature into a second feature through the conversion model, where the first feature and the second feature correspond to different feature spaces. In addition, the method also includes generating, by the language model, a text description for the image based on the second feature.

In a second aspect of the present disclosure, an apparatus for generating a text description for an image is provided. The apparatus includes a first feature generation module, configured to generate a first feature of the image through a visual encoder, where a text encoder semantically aligned with the visual encoder is used to train a conversion model and a language model. The apparatus further includes a first feature conversion module, configured to convert the first feature into a second feature through the conversion model, where the first feature and the second feature correspond to different feature spaces. In addition, the apparatus further includes a text description generation module, configured to generate, by the language model, a text description for the image based on the second feature.

In a third aspect of the present disclosure, an electronic device is provided. The electronic device includes a processor and a memory coupled with the processor. The memory has instructions stored therein, and the instructions, when executed by the processor, cause the electronic device to perform the method according to the first aspect.

In a fourth aspect of the present disclosure, a computer-readable storage medium is provided. The computer-readable storage medium stores computer-executable instructions, where the computer-executable instructions are executed by a processor to implement the method according to the first aspect.

### BRIEF DESCRIPTION OF THE DRAWINGS

The above and other features, advantages, and aspects of various embodiments of the present disclosure will become more apparent in conjunction with the accompanying drawings and with reference to following detailed descriptions. In the accompanying drawings, same or similar reference numerals denote same or similar elements.

FIG. 1 is a schematic diagram of an example environment where some embodiments of the present disclosure may be implemented;

FIG. 2 is a flowchart of a method for generating a text description for an image according to some embodiments of the present disclosure;

FIG. 3 is a schematic diagram of a process for semantically aligning a text encoder with an image encoder according to some embodiments of the present disclosure;

FIG. 4 is a schematic diagram of a process for training a conversion model and a large language model according to some embodiments of the present disclosure;

FIG. 5 is a schematic diagram of a process for fine tuning an image encoder according to some embodiments of the present disclosure;

FIG. 6 is a schematic diagram of a process for generating a text description for an image according to some embodiments of the present disclosure;

FIG. 7 is a schematic diagram of a process for model training and inferring according to some embodiments of the present disclosure;

FIG. 8 is a block diagram of an apparatus for generating a text description for an image according to some embodiments of the present disclosure; and

FIG. 9 is a block diagram of an electronic device according to some embodiments of the present disclosure.

In all the accompanying drawings, the same or similar reference numerals denote the same or similar elements.

### DETAILED DESCRIPTION OF EMBODIMENTS

It should be understood that data (including but not limited to the data itself, and data acquisition, or usage) involved in the technical solutions should comply with the requirements of corresponding laws and regulations, and relevant stipulations.

It should be understood that before the use of the technical solutions disclosed in the embodiments of the present disclosure, a user shall be informed of the type, range of use, use scenarios, etc., of personal information involved in the present disclosure in an appropriate manner in accordance with the relevant laws and regulations, and the authorization of the user shall be obtained.

For example, when an active request from the user is received, a prompt message is sent to the user to clearly prompt the user that an operation requested to be performed will require access to and use of personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt message may be sent to the user in the form of, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with relevant laws and regulations may also be applied to the implementations of the present disclosure.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term “include” and similar terms thereof should be understood as open-ended inclusions, that is, “including but not limited to”. The term “based on” should be understood as “at least partially based on.” The term “an embodiment” or “this embodiment” should be understood as “at least one embodiment”. The terms “first”, “second”, etc. may refer to different or identical objects, unless otherwise explicitly specified. Additional explicit and implicit definitions may be included below.

A multimodal large language model refers to a language model that generates text descriptions based on multimodal information, where the multimodal information mainly includes visual information and text information. Therefore, the multimodal large language model has important application value in the fields such as intention understanding, summary extraction, and content creation. Conventionally, to obtain a high-quality multimodal large language model for generating text descriptions for images, the multimodal large language model often needs to be trained using an image-text dataset. However, because the image-text dataset often includes a large amount of low-quality data (e.g., poor image and text correlation), the performance of the trained multimodal large language model in conventional solutions is often low, resulting in inaccurate text descriptions for the images.

In this embodiment of the present disclosure, a visual encoder and a text encoder which are semantically aligned are first determined. The text encoder is used to train a conversion model and the large language model, making the text encoder semantically aligned with the large language model. Therefore, the text encoder is used as an intermediary to semantically align the visual encoder with the large language model. Then, a feature (which may be referred to as a first feature) of the image may be extracted through the visual encoder, and is converted, through a conversion model, to a feature space (a converted feature may be referred to as a second feature) corresponding to the large language model, and the converted feature is processed by the large language model to generate a text description for the image.

Through the approach, the text encoder may be used as the intermediary in the training process to quickly semantically align the visual encoder with the large language model. Since the training process only involves adjustment of parameters of the conversion model and the large language model based on the text data, the negative impact of the low-quality data in the image-text dataset in the training process can be avoided, thereby improving the accuracy of semantically aligning the visual encoder with the large language model in the training process and then improving the overall model quality. In an inference process, since the visual encoder has already been aligned with the large language model, the large language model may accurately generate the text description based on the converted image feature.

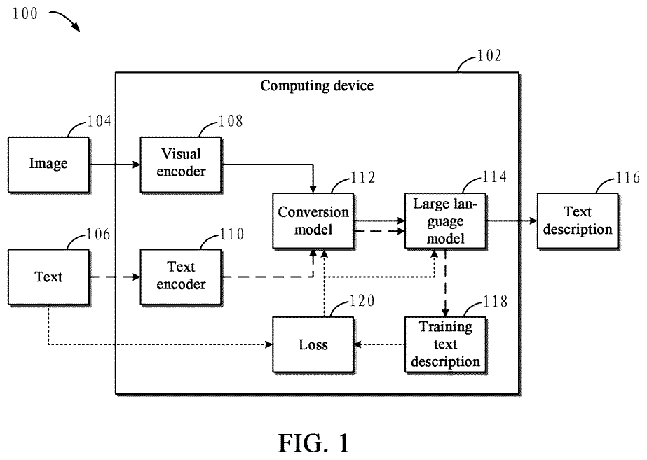

FIG. 1 is a schematic diagram of an example environment 100 where some embodiments of the present disclosure may be implemented. As shown in FIG. 1, the example environment 100 may be set as a computing device 102. The computing device 102 may be set as a computing system, a single server, a distributed server, or a cloud-based server, etc., or may also be set as a user terminal, a mobile device, a computer, etc., or even a combination of the above devices. For example, the computing device 102 may be a combination of the server and the user terminal, thereby achieving interaction with a user based on the combination.

Referring to FIG. 1, the computing device 102 stores a visual encoder 108, a text encoder 110, a conversion model 112, and a large language model 114. The visual encoder 108 and the text encoder 110 have already been semantically aligned. That is, for the same image-text pair in the image-text dataset, an image feature output by the visual encoder 108 and a text feature output by the text encoder 110 have a high similarity. For different image-text pairs in the image-text dataset, the image feature output by the visual encoder 108 and the text feature output by the text encoder 110 have a low similarity. It should be understood that the higher similarity for the same image-text pair and the lower similarity for different image-text pairs indicate a better semantic alignment effect of the visual encoder 108 and the text encoder 110.

In some embodiments, continue to refer to FIG. 1, in the training process, a text feature of a text 106 is extracted by the encoder 110, and the text feature is input into the conversion model 112 for feature conversion, thereby making the text feature satisfy feature space requirements of the input feature of the large language model 114. The large language model 114 extracts, based on the converted text feature, a training text description 118 corresponding to the text 106. It should be noted that since only the text is used to train the conversion model 112 and the large language model 114 in the training process, there are no limitations on a source of the text 106 in this embodiment. That is, the text 106 may be either a text from the image-text dataset or another text in addition to the image-text dataset.

Then, after the large language model 114 generates the training text description 118 for the text 106, a loss 120 is determined based on the text 106 and the training text description 118. Parameters in the conversion model 112 and the large language model 114 are trained through backpropagation, and parameters in the visual encoder 108 and the text encoder 110 are frozen in the training process. After multiple iterations, when the loss 120 satisfies a convergence condition, the training of the conversion model 112 and the large language model 114 can be completed. It should be understood that after training, the text 106 is aligned with the training text description 118. Therefore, the text encoder 110 and the large language model 114 are semantically aligned, and accordingly, the visual encoder 108 and the large language model 114 are semantically aligned as well

In some embodiments, continue to refer to FIG. 1, in an inference stage, an image 104 is acquired, and an image feature of the image 104 is extracted through the visual encoder 108. Then, the image feature is converted through the trained conversion model 112, and the converted image feature is input into the trained large language model 114. The large language model 114 extracts a text description 116 for the image 104 based on the converted image feature.

Through the method, the text encoder 110 may be used as the intermediary in the training process to quickly semantically align the visual encoder 108 with the large language model 114. Since the training process only involves adjustment of the parameters of the conversion model 112 and the large language model 114 based on the text data, the negative impact of the low-quality data in the image-text dataset in the training process can be avoided, thereby improving the accuracy of semantically aligning the visual encoder 108 with the large language model 114 in the training process and then improving the overall model quality. In the inference process, since the visual encoder 108 has already been aligned with the large language model 114, the large language model 114 may accurately generate the text description based on the converted image feature.

It should be understood that the architecture and functions in the example environment 100 are described for illustrative purposes only, and do not imply any limitations on the scope of the present disclosure. This embodiment of the present disclosure may also be applied to other environments with different structures and/or functions.

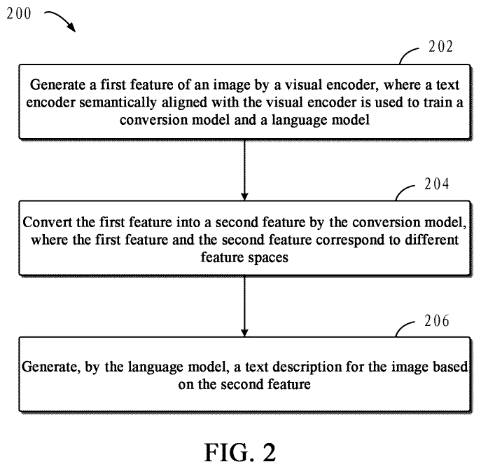

The process according to this embodiment of the present disclosure is described in detail in conjunction with FIG. 2 to FIG. 9 below. For ease of understanding, specific data mentioned in the following description is exemplary and is not intended to limit the scope of protection of the present disclosure. It should be understood that the embodiments described below may also include additional actions not shown and/or may omit shown actions, and the scope of the present disclosure is not limited in this aspect.

FIG. 2 is a flowchart of a method 200 for generating a text description for an image according to some embodiments of the present disclosure. In some embodiments, the computing device 102 in FIG. 1 may serve as an executing body of the method 200.

At a block 202, the first feature of the image is generated by the visual encoder, and the text encoder semantically aligned with the visual encoder is used to train the conversion model and the language model. In some embodiments, in the environment 100 shown in FIG. 1, the image 104 is acquired, and the image feature (which may be referred to as the first feature) of the image 104 is extracted through the visual encoder 108. The visual encoder 108 is semantically aligned with the text encoder 110. The text encoder 110 is used to train the conversion model 112 and the large language model 114.

In some embodiments, the image 104 may be directly acquired from a database or received from another device, such as a user terminal. Alternatively or additionally, a video may be acquired from the database or another device, and the image 104 is extracted from a plurality of video frames of the video. In some embodiments, the plurality of video frames of the video may be sampled at a certain time interval, and the sampled video frame is used as the image 104.

In some embodiments, in the training process, a text feature of the text 106 is extracted by the encoder 110, and the text feature is input into the conversion model 112 for feature conversion, thereby making the text feature satisfy the feature space requirements of the input feature of the large language model 114. The large language model 114 extracts, based on the converted text feature, a training text description corresponding to the text 106. It should be noted that since only the text is used to train the conversion model 112 and the large language model 114 in the training process, there are no limitations on a source of the text 106 in this embodiment. That is, the text 106 may be either a text from the image-text dataset or another text in addition to the image-text dataset.

Then, after the large language model 114 generates the training text description 118 for the text 106, a loss 120 is determined based on the text 106 and the training text description 118. Parameters in the conversion model 112 and the large language model 114 are trained through backpropagation, and parameters in the visual encoder 108 and the text encoder 110 are frozen in the training process. After multiple iterations, when the loss 120 satisfies a convergence condition, the training of the conversion model 112 and the large language model 114 can be completed. It should be understood that after training, the text 106 is aligned with the training text description 118. Therefore, the text encoder 110 and the large language model 114 are semantically aligned, and accordingly, the visual encoder 108 and the large language model 114 are semantically aligned as well.

At a block 204, the conversion model converts the first feature into the second feature, and the first feature and the second feature correspond to different feature spaces. In some embodiments, in the environment 100 shown in FIG. 1, after the visual encoder 108 extracts the image feature of the image 104, the trained conversion model 112 converts the image feature (the converted image feature may be referred to as the second feature), such that a feature space for the converted image feature is adaptive to a feature space for an input feature of the large language model 114. In some embodiments, the feature space includes a feature size, such as a feature length. Alternatively or additionally, the feature space includes a feature spatial distribution.

At a block 206, the language model generates a text description for the image based on the second feature. In some embodiments, in the environment 100 shown in FIG. 1, the converted image feature is input into the large language model 114, and the large language model 114 generates, based on the converted image feature, the text description 116 corresponding to the image 104. In some embodiments, a prompt content associated with the image 104 may be set, and the large language model 114 generates, based on the converted image feature and the prompt content, the text description 116 corresponding to the image 104. The prompt content may be used to guide the large language model 114 to generate a corresponding type of text description 116. For example, the prompt content may be set as “Please describe this picture”, and the type of the generated text description 116 is a descriptive content for the image 104. Through the method, the text description 116 that is more accurate and satisfies requirements can be generated.

In this embodiment of the present disclosure, the text encoder may be used as the intermediary in the training process to quickly semantically align the visual encoder with the large language model. Since the training process only involves adjustment of parameters of the conversion model and the large language model based on the text data, the negative impact of the low-quality data in the image-text dataset in the training process can be avoided, thereby improving the accuracy of semantically aligning the visual encoder with the large language model in the training process and then improving the overall model quality. In the inference process, since the visual encoder has already been aligned with the large language model, the large language model may accurately generate the text description based on the converted image feature.

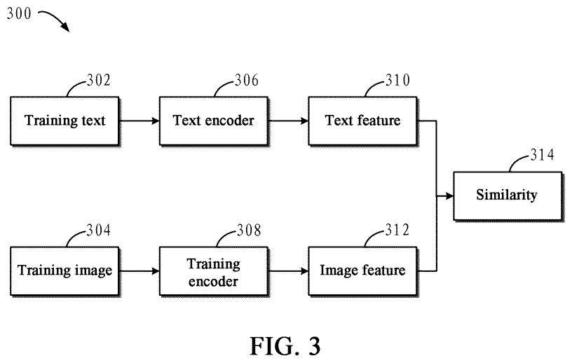

FIG. 3 is a schematic diagram of a process 300 for semantically aligning a text encoder with an image encoder according to some embodiments of the present disclosure. As mentioned above, the text encoder 306 and the image encoder 308 are semantically aligned, which may be, for example, a pair of encoders obtained through contrastive learning. The process 300 illustrates a contrastive learning-based training process for the text encoder 306 and the image encoder 308. In some embodiments, the text encoder 306 may be, for example, a converter network with attention heads, and the image encoder 308 may be various residual networks. The present disclosure does not limit the structure of the text encoder 306 and the image encoder 308.

In some embodiments, training data (which may be referred to as a training image-text pair) for the text encoder 306 and the image encoder 308 includes a training text 302 and a training image 304 which are paired. For example, the training text 302 may be a classification label for the training image 304. Therefore, the training text 302 and the training image 304 used as the training data are semantically related. The text encoder 306 generates a corresponding text feature 310 based on the training text 302 in the training data. The image encoder 308 generates a corresponding image feature 312 based on the training image 304 in the training data. The text encoder 306 and the image encoder 308 are trained by constructing a similarity 314 of a positive sample and a negative sample about contrastive learning.

In some embodiments, a text-image alignment model is acquired and trained through a text-image pair, such that a visual encoding subnetwork and a text encoding subnetwork in the model can be semantically aligned. Then, the visual encoding subnetwork is set as the image encoder 308 herein, and the text encoding subnetwork is set as the text encoder 306 herein. Through the method, the text encoder 306 and the image encoder 308 which are semantically aligned can be quickly trained.

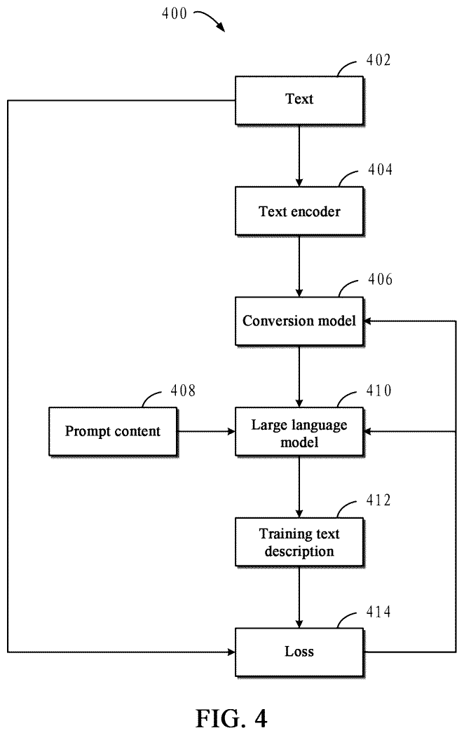

FIG. 4 is a schematic diagram of a process 400 for training a conversion model and a large language model according to some embodiments of the present disclosure. In some embodiments, during forward propagation of the process 400, a text 402 is acquired and input into a text encoder 404, and the text encoder 404 extracts a text feature (which may be referred to as a first text feature) from the text 402. The text feature is then input into a conversion model 406, and the conversion model 406 converts the text feature (the converted text feature may be referred to as a second text feature), such that the converted text feature can satisfy feature space requirements of the input feature of a large language model 410.

Then, the converted text feature is processed by the large language model 410 to generate a training text description 412 corresponding to the text 402. In some embodiments, in conjunction with a prompt content 408, the prompt content 408 and the text feature are processed based on the large language model 410 to generate the training text description 412 corresponding to the text 402. The prompt content 408 may be used to guide the large language model to generate the corresponding type of training text description 412.

Continue to refer to FIG. 4, during backpropagation of the process 400, a loss 414 in the training process is determined based on the text 402 and the training text description 412. By adjusting parameters in the conversion model 406 and the large language model 410, the loss 414 is made to satisfy a convergence condition. After the loss 414 satisfies the convergence condition, it may be determined that the training of the conversion model 406 and the large language model 410 is completed.

It should be understood that since a training objective of the process 400 is to semantically align the text encoder 404 with the large language model 410, so as to make the visual encoder (e.g., the image encoder 308 in FIG. 3) semantically aligned with the text encoder 404 also semantically aligned with the large language model 410, only the parameters in the conversion model 406 and the large language model 410 are adjusted in the training process, while the parameters in the text encoder 404 are not adjusted (otherwise, although the adjusted text encoder 404 can be aligned with the large language model 410, the visual encoder cannot be aligned with the large language model 410).

Through the method, the text encoder 404 may be used as the intermediary in the training process to quickly semantically align the visual encoder with the large language model 410. Since the training process only involves adjustment of the parameters of the conversion model 406 and the large language model 410 based on the text 402, the negative impact of low-quality image data in the image-text dataset in the training process can be avoided, thereby improving the accuracy of semantically aligning the visual encoder with the large language model 410 in the training process and then improving the overall model quality.

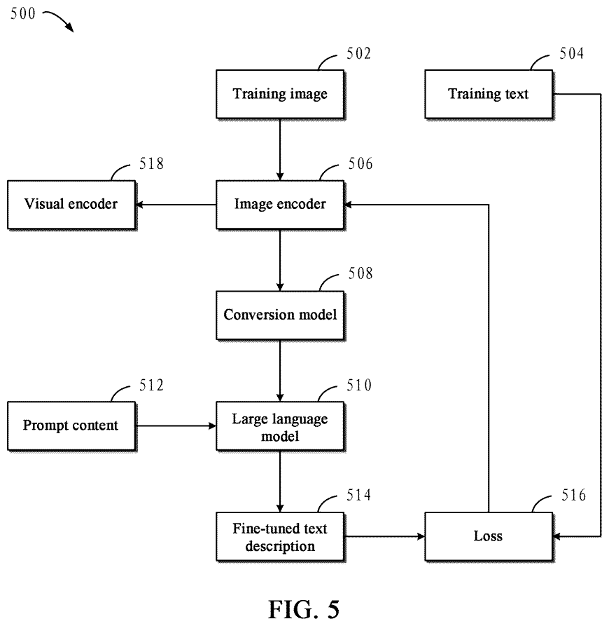

FIG. 5 is a schematic diagram of a process 500 for fine tuning an image encoder according to some embodiments of the present disclosure. After completing the training of a conversion model 508 and a large language model 510 in the process 400, the image encoder 506 may be further fine tuned. In some embodiments, an image-text data pair for training is acquired, and includes a training image 502 and a training text 504. The image encoder 506 extracts an image feature (which may be referred to as a first image feature) of the training image 502, where the image encoder 506 is semantically aligned with the text encoder (e.g., the text encoder 404 in FIG. 4). The image feature is converted through the conversion model 508 (the converted image feature may be referred to as a second image feature), such that the converted image feature satisfies feature space requirements of the input feature of the large language model 510.

Then, the large language model 510 processes the converted image feature to generate a fine-tuned text description 514. In some embodiments, a prompt content 512 (which may be referred to as a training prompt content) corresponding to an image text may be acquired, and the prompt content 512 and the converted image feature are processed through the large language model 510 to generate the fine-tuned text description 514. The prompt content 512 is used to guide the large language model 510 to generate the corresponding type of fine-tuned text description 514.

Continue to refer to FIG. 5, after the fine-tuned text description 514 is generated, a loss 516 is determined based on the training text 504 paired with the training image 502, as well as the fine-tuned text description 514, and parameters in the image encoder 506 are fine tuned through the loss 516. After the loss 516 satisfies a convergence condition, the trained image encoder 506 is used as a visual encoder 518. In some embodiments, after the loss 516 is determined, the image encoder 506, the conversion model 508, and the large language model 510 may also be simultaneously fine tuned using the loss 516 to improve the overall model accuracy.

Through the method, the image encoder 506 may be continuously fine tuned after being aligned with the large language model 510, thereby further improving the image feature extraction capability of the image encoder 506 and adaptability between the image encoder 506 and the large language model 510 so as to improve the accuracy of the text description for the image.

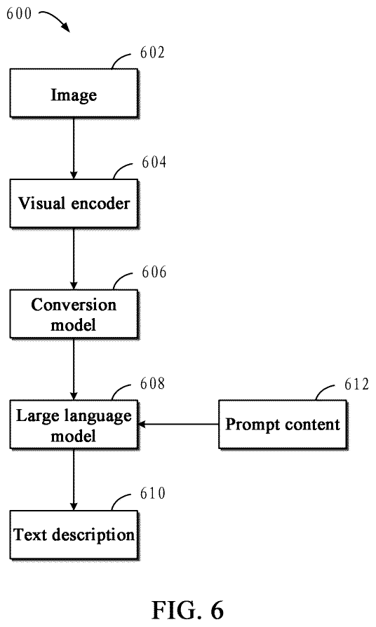

FIG. 6 is a schematic diagram of a process 600 for generating a text description for an image according to some embodiments of the present disclosure. In some embodiments, after training a conversion model 606 and a large language model 608 through a text encoder, a visual encoder 604 corresponding to the text encoder is determined. An image 602 is processed by the visual encoder 604 to generate an image feature (which may be referred to as a first feature). The conversion model 606 converts the image feature (the converted image feature may be referred to as a second feature), such that the converted image feature can satisfy feature space of the input feature of the large language model 608.

Then, the large language model 608 processes the converted image feature to generate a text description 610. In some embodiments, a prompt content 612 corresponding to the image may be acquired, and the prompt content 612 and the converted image feature are processed through the large language model 608 to generate the text description 610 corresponding to the image 602. The prompt content 612 is used to guide the large language model 608 to generate the corresponding type of text description 610. Through the method, in the inference process, since the visual encoder 604 has already been aligned with the large language model 608, the large language model 608 may accurately generate the text description based on the converted image feature.

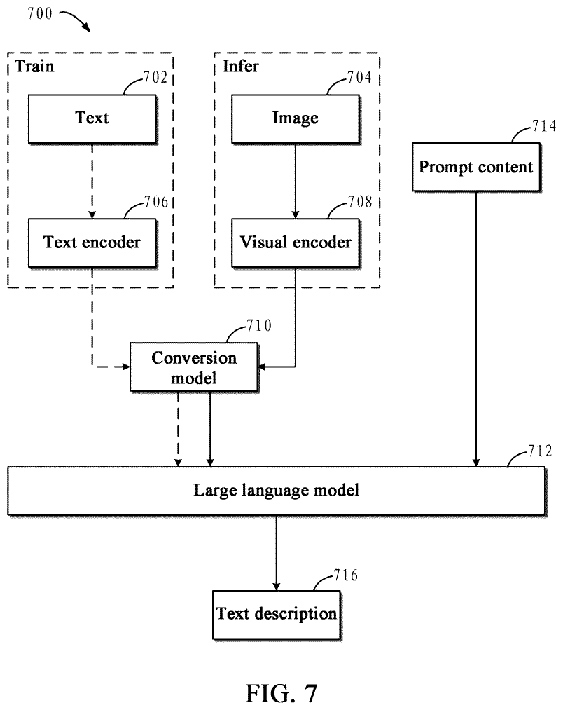

FIG. 7 is a schematic diagram of a process 700 for model training and inferring according to some embodiments of the present disclosure. In some embodiments, in a training stage, a text 702 is acquired and input into a text encoder 706, and the text encoder 706 extracts a text feature of the text 702. The text feature is then input into a conversion model 710, and the conversion model 710 converts the text feature, such that the converted text feature can satisfy feature space requirements of the input feature of a large language model 712. Then, the converted text feature is processed by the large language model 712 to generate a training text description corresponding to the text 702, thereby training the conversion model 710 and the large language model 712.

In some embodiments, a loss in the training process is determined through the text 702 and the training text description, and by adjusting parameters in the conversion model 710 and the large language model 712, the loss satisfies a convergence condition. After the loss satisfies the convergence condition, it may be determined that the training of the conversion model 710 and the large language model 712 is completed. For example, when the text 702 is “A dog is running on the lawn”, and the training text description is “A dog is running on the lawn,” it may be considered that the loss satisfies the convergence condition.

In some embodiments, in the inference stage, after training the conversion model 710 and the large language model 712 through the text encoder 706, a visual encoder 708 corresponding to the text encoder 706 is determined. An image 704 is processed by the visual encoder 708 to generate an image feature. The conversion model 710 converts the image feature, such that the converted image feature can satisfy feature space of the input feature of the large language model 710.

Then, the large language model 710 processes the converted image feature to generate a text description 716. In some embodiments, a prompt content 714 corresponding to the image 704 may be acquired, and the prompt content 714 and the converted image feature are processed through the large language model 712 to generate the text description 716 corresponding to the image 704. The prompt content 714 is used to guide the large language model 712 to generate the corresponding type of text description 716.

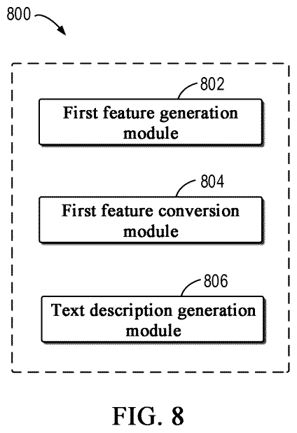

FIG. 8 is a block diagram of an apparatus 800 for generating a text description for an image according to some embodiments of the present disclosure. Referring to FIG. 8, the apparatus 800 includes a first feature generation module 802, configured to generate a first feature of the image through a visual encoder, where a text encoder semantically aligned with the visual encoder is used to train a conversion model and a language model. The apparatus 800 further includes a first feature conversion module 804, configured to convert the first feature into a second feature through the conversion model, where the first feature and the second feature correspond to different feature spaces. In addition, the apparatus 800 further includes a text description generation module 806, configured to generate, by the language model, a text description for the image based on the second feature.

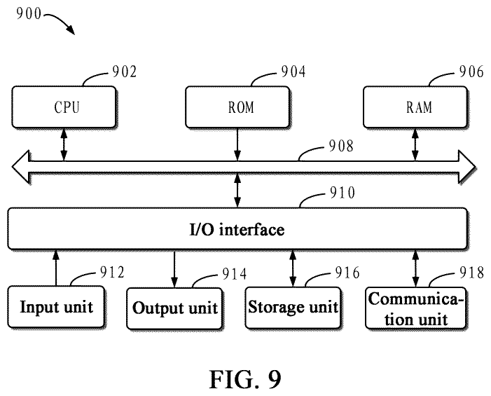

FIG. 9 is a block diagram of an electronic device 900 according to some embodiments of the present disclosure. The device 900 may be a device or apparatus described in the embodiments of the present disclosure. As shown in FIG. 9, the device 900 includes a central processing unit (CPU) and/or a graphics processing unit (GPU) 902, which may perform various suitable actions and processes according to computer program instructions stored in a read-only memory (ROM) 904 or computer program instructions loaded from a storage unit 916 into a random access memory (RAM) 906. The RAM 906 may also store various programs and data required for the operation of the storage device 900. The CPU/GPU 902, the ROM 904, and the RAM 906 are connected with one another through a bus 908. An input/output (I/O) interface 910 is also connected to the bus 908. Although not shown in FIG. 9, the device 900 may also include a coprocessor.

A plurality of components in the device 900 are connected to the I/O interface 910, including an input unit 912 such as a keyboard and a mouse; an output unit 914 such as various types of displays and speakers; the storage unit 916 such as a disk and an optical disc; and a communication unit 918 such as a network card, a modem, and a wireless communication transceiver. The communication unit 918 allows the device 900 to exchange information/data with other devices through a computer network such as the Internet, and/or various telecommunication networks.

The various methods or processes described above may be performed by the CPU/GPU 902. For example, in some embodiments, the method may be implemented as a computer software program that is tangibly included in a machine-readable medium, such as the storage unit 916. In some embodiments, part or all of the computer program may be loaded and/or installed onto the device 900 via the ROM 904 and/or the communication unit 918. When the computer program is loaded into the RAM 906 and executed by the CPU/GPU 902, one or more of steps or actions of the method or the process described above may be performed.

In some embodiments, the methods and processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used here is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device via a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operation of the present disclosure may be assembly instructions, instruction set architecture (ISA) instructions, machine instructions, machine-dependent instructions, microcode, firmware instructions, status setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or wide area network (WAN), or may be connected to the external computer (e.g., utilizing an Internet service provider for Internet connectivity). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or the another programmable data processing apparatus, produce an apparatus for implementing functions/actions specified in one or more blocks in the flowcharts and/or block diagrams. These computer-readable program instructions may also be stored in the computer-readable storage medium, and these instructions make the computer, the programmable data processing apparatus, and/or another device operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the various embodiments of the present disclosure. In this regard, each block in the flowcharts or the block diagrams may represent a module, a program segment, or a portion of code, and the module, the program segment, or the portion of code includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above description is illustrative, rather than exhaustive, and is not limited to the disclosed various embodiments. Numerous modifications and alterations are apparent to those of ordinary skill in the art without departing from the scope and spirit of the illustrated embodiments. The selection of the terms as used herein is intended to best explain the principles and practical applications of the various embodiments, or improvements to technologies on the market, or to enable other persons of ordinary skill in the art to understand the various embodiments disclosed herein.

Some example implementations of the present disclosure are listed below.

Example 1. A method for generating a text description for an image, including:
generating a first feature of the image through a visual encoder, where a text encoder semantically aligned with the visual encoder is used to train a conversion model and a language model;
converting the first feature into a second feature through the conversion model, where the first feature and the second feature correspond to different feature spaces; and
generating, by the language model, a text description for the image based on the second feature.

Example 2. The method according to Example 1, where the generating, by the language model, a text description for the image based on the second feature includes:
acquiring a prompt content for the image, where the prompt content is used to indicate a type of the text description; and
generating, by the language model, the text description for the image based on the second feature and the prompt content.

Example 3. The method according to Example 1 or 2, further including:
generating a first text feature of a training text through the text encoder;
converting the first text feature into a second text feature through the conversion model, where the first text feature and the second text feature correspond to different feature spaces;
generating, by the language model, a training text description based on the second text feature; and
training the conversion model and the language model based on a loss between the training text and the training text description.

Example 4. The method according to any one of Examples 1 to 3, where features of a training image in a training image-text pair generated by the visual encoder and features of a training text in the training image-text pair generated by the text encoder satisfy similarity conditions.

Example 5. The method according to any one of Examples 1 to 4, where the training the conversion model and the language model includes:
adjusting parameters in the conversion model and the language model based on a loss between the training text and the training text description, where in the adjusting process, parameters in the visual encoder and the text encoder are unchanged; and
determining the completion of the training of the conversion model and the language model in response to the loss between the training text and the training text description satisfying the convergence condition.

Example 6. The method according to any one of Examples 1 to 5, where the visual encoder is a visual encoding sub-model in a text-image alignment model, and the text encoder is a text encoding sub-model in the text-image alignment model.

Example 7. The method according to any one of Examples 1 to 6, further including:
generating a first image feature of a training image in a training image-text pair by an image encoder semantically aligned with the text encoder;
converting the first image feature into a second image feature through the conversion model, where the first image feature and the second image feature correspond to different feature spaces;
generating, by the language model, a fine-tuned text description for the training image based on the second image feature; and
fine tuning the image encoder based on the loss between the training text in the training image-text pair and the fine-tuned text description.

Example 8. The method according to any one of Examples 1 to 7, where the generating, by the language model, a fine-tuned text description for the training image based on the second image feature includes:
acquiring a training prompt content for the training image-text pair, where the training prompt content is used to indicate a type of the fine-tuned text description; and
generating, by the language model, the fine-tuned text description for the training image based on the second image feature and the training prompt content.

Example 9. The method according to any one of Examples 1 to 8, where the feature space includes at least one of a feature size and a feature space distribution.

Example 10. The method according to any one of Examples 1 to 9, further including:
acquiring the image; and
wherein acquiring the image includes:
acquiring a video; and
extracting the image from a video frame of the video.

Example 11. An apparatus for generating a text description for an image, including:
a first feature generation module, configured to generate a first feature of the image through a visual encoder, where a text encoder semantically aligned with the visual encoder is used to train a conversion model and a language model;
a first feature conversion module, configured to convert the first feature into a second feature through the conversion model, where the first feature and the second feature correspond to different feature spaces; and
a text description generation module, configured to generate, by the language model, a text description for the image based on the second feature.

Example 12. The apparatus according to Example 11, where the text description generation module is further configured to:
acquire a prompt content for the image, where the prompt content is used to indicate a type of the text description; and
generate, by the language model, the text description for the image based on the second feature and the prompt content.

Example 13. The apparatus according to Example 11 or 12, further including:
a first text feature generation module, configured to generate a first text feature of a training text through the text encoder;
a first text feature conversion module, configured to convert the first text feature into a second text feature through the conversion model, where the first text feature and the second text feature correspond to different feature spaces;
a training text description generation module, configured to generate, by the language model, a training text description based on the second text feature; and
a training module, configured to train the conversion model and the language model based on a loss between the training text and the training text description.

Example 14. The apparatus according to any one of Examples 11 to 13, where features of a training image in a training image-text pair generated by the visual encoder and features of a training text in the training image-text pair generated by the text encoder satisfy similarity conditions.

Example 15. The apparatus according to any one of Examples 11 to 14, where the training module is further configured to:
adjust parameters in the conversion model and the language model based on a loss between the training text and the training text description, where in the adjusting process, parameters in the visual encoder and the text encoder are unchanged; and
determine the completion of the training of the conversion model and the language model in response to the loss between the training text and the training text description satisfying a convergence condition.

Example 16. The apparatus according to any one of Examples 11 to 15, where the visual encoder is a visual encoding sub-model in a text-image alignment model, and the text encoder is a text encoding sub-model in the text-image alignment model.

Example 17. The apparatus according to any one of Examples 11 to 16, further including:
a first image feature generation module, configured to generate a first image feature of a training image in a training image-text pair generated by an image encoder semantically aligned with the text encoder;
a first image feature conversion module, configured to convert the first image feature into a second image feature through the conversion model, where the first image feature and the second image feature correspond to different feature spaces;
a fine-tuned text description generation module, configured to generate, by the language model, a fine-tuned text description for the training image based on the second image feature; and
a fine-tuning module, configured to fine tune the image encoder based on the loss between the training text in the training image-text pair and the fine-tuned text description.

Example 18. The apparatus according to any one of Examples 11 to 17, where the fine-tuned text description generation module is further configured to:
acquire a training prompt content for the training image-text pair, where the training prompt content is used to indicate a type of the fine-tuned text description; and
generate, by the language model, the fine-tuned text description for the training image based on the second image feature and the training prompt content.

Example 19. The apparatus according to any one of Examples 11 to 18, where the feature space includes at least one of a feature size and a feature space distribution.

Example 20. The apparatus according to any one of Examples 11 to 19, further including:
an image acquiring module, configured to acquire the image; and
the image acquiring module is further configured to:
acquire a video; and
extract the image from a video frame of the video.

Example 21. An electronic device, including:
a processor; and
a memory coupled with the processor, where the memory has instructions stored therein, the instructions, when executed by the processor, cause the electronic device to perform actions, and the actions include:
generating a first feature of an image through a visual encoder, where a text encoder semantically aligned with the visual encoder is used to train a conversion model and a language model;
converting the first feature into a second feature through the conversion model, where the first feature and the second feature correspond to different feature spaces; and
generating, by the language model, a text description for the image based on the second feature.

Example 22. The electronic device according to Example 21, where the generating, by the language model, a text description for the image based on the second feature includes:
acquiring a prompt content for the image, where the prompt content is used to indicate a type of the text description; and
generating, by the language model, the text description for the image based on the second feature and the prompt content.

Example 23. The electronic device according to Example 21 or 22, where the actions further include:
generating a first text feature of a training text through the text encoder;
converting the first text feature into a second text feature through the conversion model, where the first text feature and the second text feature correspond to different feature spaces;
generating, by the language model, a training text description based on the second text feature; and
training the conversion model and the language model based on a loss between the training text and the training text description.

Example 24. The electronic device according to any one of Examples 21 to 23, where features of a training image in a training image-text pair generated by the visual encoder and features of a training text in the training image-text pair generated by the text encoder satisfy similarity conditions.

Example 25. The electronic device according to any one of Examples 21 to 24, where the training the conversion model and the language model includes:
adjusting parameters in the conversion model and the language model based on a loss between the training text and the training text description, where in the adjusting process, parameters in the visual encoder and the text encoder are unchanged; and
determining the completion of the training of the conversion model and the language model in response to the loss between the training text and the training text description satisfying a convergence condition.

Example 26. The electronic device according to any one of Examples 21 to 25, where the visual encoder is a visual encoding sub-model in a text-image alignment model, and the text encoder is a text encoding sub-model in the text-image alignment model.

Example 27. The electronic device according to any one of Examples 21 to 26, where the actions further include:
generating a first image feature of a training image in a training image-text pair generated by an image encoder semantically aligned with the text encoder;
converting the first image feature into a second image feature through the conversion model, where the first image feature and the second image feature correspond to different feature spaces;
generating, by the language model, a fine-tuned text description for the training image based on the second image feature; and
fine tuning the image encoder based on the loss between the training text in the training image-text pair and the fine-tuned text description.

Example 28. The electronic device according to any one of Examples 21 to 27, where the generating, by a language model, a fine-tuned text description for the training image based on the second image feature includes:
acquiring a training prompt content for the training image-text pair, where the training prompt content is used to indicate a type of the fine-tuned text description; and
generating, by the language model, the fine-tuned text description for the training image based on the second image feature and the training prompt content.

Example 29. The electronic device according to any one of Examples 21 to 28, where the feature space includes at least one of a feature size and a feature space distribution.

Example 30. The electronic device according to any one of Examples 21 to 29, where the actions further include:
acquiring the image; and
the acquiring the image includes:
acquire a video; and
extract the image from a video frame of the video.

Example 31. A computer-readable storage medium, having computer-executable instructions stored therein, where the computer-executable instructions, when executed by a processor, implement the method according to any one of Examples 1 to 10.

Example 32. A computer program product, where the computer program product is tangibly stored in a computer-readable medium and includes computer-executable instructions, and the computer-executable instructions, when executed by a device, cause the device to perform the method according to any one of Examples 1 to 10.

Although the present disclosure has been described by adopting a language specific to structural features and/or method logical actions, it should be understood that the subject matter limited in the appended claims is not necessarily limited to the specific features or actions described above. On the contrary, the specific features and the actions described above are merely example forms for implementing the claims.

I/we claim:

1. A method for generating a text description for an image, comprising:
generating a first feature of the image by a visual encoder, wherein a text encoder semantically aligned with the visual encoder is used to train a conversion model and a language model;
converting the first feature into a second feature by the conversion model, wherein the first feature and the second feature correspond to different feature spaces; and
generating, by the language model, a text description for the image based on the second feature.

2. The method according to claim 1, wherein generating, by the language model, a text description for the image based on the second feature comprises:
acquiring a prompt content for the image, wherein the prompt content is used to indicate a type of the text description; and
generating, by the language model, the text description for the image based on the second feature and the prompt content.

3. The method according to claim 1, further comprising:
generating a first text feature of a training text by the text encoder;
converting the first text feature into a second text feature by the conversion model, wherein the first text feature and the second text feature correspond to different feature spaces;
generating, by the language model, a training text description based on the second text feature; and
training the conversion model and the language model based on a loss between the training text and the training text description.

4. The method according to claim 3, wherein features of a training image in a training image-text pair generated by the visual encoder and features of a training text in the training image-text pair generated by the text encoder satisfy similarity conditions. 5 The method according to claim 3, wherein training the conversion model and the language model comprises:
adjusting parameters in the conversion model and the language model based on a loss between the training text and the training text description, wherein in adjusting process, parameters in the visual encoder and the text encoder are unchanged; and
determining completion of the training of the conversion model and the language model in response to the loss between the training text and the training text description satisfying a convergence condition.

6. The method according to claim 4, wherein the visual encoder is a visual encoding sub-model in a text-image alignment model, and the text encoder is a text encoding sub-model in the text-image alignment model.

7. The method according to claim 3, further comprising:
generating a first image feature of a training image in a training image-text pair by an image encoder semantically aligned with the text encoder;
converting the first image feature into a second image feature by the conversion model, wherein the first image feature and the second image feature correspond to different feature spaces;
generating, by the language model, a fine-tuned text description for the training image based on the second image feature; and
fine tuning the image encoder based on a loss between the training text in the training image-text pair and the fine-tuned text description.

8. The method according to claim 7, wherein generating, by the language model, a fine-tuned text description for the training image based on the second image feature comprises:
acquiring a training prompt content for the training image-text pair, wherein the training prompt content is used to indicate a type of the fine-tuned text description; and
generating, by the language model, the fine-tuned text description for the training image based on the second image feature and the training prompt content.

9. The method according to claim 1, wherein the feature space comprises at least one of a feature size and a feature space distribution.

10. The method according to claim 1, further comprising:
acquiring the image;
wherein acquiring the image comprises:
acquiring a video; and
extracting the image from a video frame of the video.

11. An electronic device, comprising:
a processor; and
a memory coupled with the processor, wherein the memory has instructions stored therein, and the instructions, when executed by the processor, cause the electronic device to:
generate a first feature of the image by a visual encoder, wherein a text encoder semantically aligned with the visual encoder is used to train a conversion model and a language model;
convert the first feature into a second feature by the conversion model, wherein the first feature and the second feature correspond to different feature spaces; and
generate, by the language model, a text description for the image based on the second feature.

12. The electronic device according to claim 11, wherein the instructions causing the electronic device to generate, by the language model, a text description for the image based on the second feature further cause the electronic device to:
acquire a prompt content for the image, wherein the prompt content is used to indicate a type of the text description; and
generate, by the language model, the text description for the image based on the second feature and the prompt content.

13. The electronic device according to claim 11, the instructions further cause the electronic device to:
generate a first text feature of a training text by the text encoder;
convert the first text feature into a second text feature by the conversion model, wherein the first text feature and the second text feature correspond to different feature spaces;
generate, by the language model, a training text description based on the second text feature; and
train the conversion model and the language model based on a loss between the training text and the training text description.

14. The electronic device according to claim 13, wherein features of a training image in a training image-text pair generated by the visual encoder and features of a training text in the training image-text pair generated by the text encoder satisfy similarity conditions.

15. The electronic device according to claim 13, wherein the instructions causing the electronic device to train the conversion model and the language model further cause the electronic device to:
adjust parameters in the conversion model and the language model based on a loss between the training text and the training text description, wherein in adjusting process, parameters in the visual encoder and the text encoder are unchanged; and
determine completion of the training of the conversion model and the language model in response to the loss between the training text and the training text description satisfying a convergence condition.

16. The electronic device according to claim 14, wherein the visual encoder is a visual encoding sub-model in a text-image alignment model, and the text encoder is a text encoding sub-model in the text-image alignment model.

17. The electronic device according to claim 13, the instructions further cause the electronic device to:
generate a first image feature of a training image in a training image-text pair by an image encoder semantically aligned with the text encoder;
convert the first image feature into a second image feature by the conversion model, wherein the first image feature and the second image feature correspond to different feature spaces;
generate, by the language model, a fine-tuned text description for the training image based on the second image feature; and
fine tune the image encoder based on a loss between the training text in the training image-text pair and the fine-tuned text description.

18. The electronic device according to claim 17, wherein the instructions causing the electronic device to generate, by the language model, a fine-tuned text description for the training image based on the second image feature further cause the electronic device to:
acquire a training prompt content for the training image-text pair, wherein the training prompt content is used to indicate a type of the fine-tuned text description; and
generate, by the language model, the fine-tuned text description for the training image based on the second image feature and the training prompt content.

19. The electronic device according to claim 11, wherein the feature space comprises at least one of a feature size and a feature space distribution.

20. A non-transitory computer-readable storage medium, having computer-executable instructions stored therein, wherein the computer-executable instructions, when executed by a processor, cause the processor to:
generate a first feature of the image by a visual encoder, wherein a text encoder semantically aligned with the visual encoder is used to train a conversion model and a language model;
convert the first feature into a second feature by the conversion model, wherein the first feature and the second feature correspond to different feature spaces; and
generate, by the language model, a text description for the image based on the second feature.
